(19) United States
(12) Patent Application Publication
(10) Pub. No.: US 2003/0181994 A1
(43) Pub. Date: Sep. 25, 2003

(54) Microprocessor performing efficient external bus access

(75) Inventor: Kazuaki Mizoguchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/378,607

(22) Filed: Mar. 5, 2003

(30) Foreign Application Priority Data
Mar. 19, 2002 (JP) 2002-77175

(51) Int. Cl. G05B 19/18

(52) U.S. Cl. 700/2; 700/5

(57) ABSTRACT

The present invention is a microprocessor including a bus master and a system bus, comprising: an external bus interface that functions as an interface between the system bus and an external bus connected to an external memory. The external bus interface comprises: (1) a batch read control section, which, in response to a batch read instruction from the bus master, repeatedly accesses the external bus in accordance with a batch read address, reads out data from the external memory and stores the data in a buffer; and (2) an access switching section, which, in response to an ordinary read instruction from the bus master following the batch read operation, outputs data stored in the buffer to the system bus without accessing the external bus when the corresponding ordinary read address is the batch read address.

### CROSS-REFERENCE TO RELATED APPLICATIONS

This application is based upon and claims the benefit of priority from the prior Japanese Patent Application No. 2002-77175, filed on Mar. 19,2002, the entire contents of which are incorporated herein by reference.

### BACKGROUND OF THE INVENTION

1. Field of the Invention

The present invention relates to a microprocessor, and more particularly to a microprocessor comprising an external bus interface which shortens the apparent latency of access to an external memory connected via an external bus to thus permit an increase in the usage efficiency of the system bus.

2. Description of the Related Art

A microprocessor normally contains a system bus that connects: bus masters such as a CPU and a direct memory access controller (referred to as “DMAC” hereinbelow), and the like; a ROM for storing programs, data, or similar; and a random access memory (RAM). The microprocessor is also connected via an external bus to an external memory, an LSI device having predetermined functions, and the like. Consequently, an external bus interface is provided in the microprocessor, between the system bus and the external bus.

Further, in addition to an external bus interface, microprocessors of recent years have been known to comprise a high-speed memory interface for connecting high-speed DRAM via a dedicated external memory bus. Also, a flash memory or similar, which is non-volatile memory, is connected via the external bus to the external bus interface, and SDRAM, which is high-speed DRAM, is connected via the external memory bus to the high-speed memory interface. By means of such a constitution, when the system is in a sleep state, user settings data, image data, and the like, are stored in the external flash memory, and the SDRAM power source is turned OFF to save on electrical power. When the system returns from the sleep state to an active state, the contents of the flash memory are downloaded to the SDRAM, and, when the system returns to the sleep state, the contents of the SDRAM are downloaded once again to the flash memory and the power source of the SDRAM is turned OFF.

The data transfer involved in such downloads is implemented as a result of the system bus master, namely the CPU or DMAC, or the like, designating a transfer source address and a transfer destination address and iterating read access and write access instructions. For example, when the data in the external flash memory is transferred to the SDRAM, the transfer source address is set to the address of the flash memory, and the transfer destination address is set to the address of the SDRAM, whereupon data is read from the flash memory and then written via the system bus to the SDRAM. That is, the data transfer is performed by iterating a read instruction and a write instruction which are issued by the bus master, and the system bus is occupied during the data transfer.

However, when the transfer source is an external flash memory, the readout latency is long in comparison with that for SDRAM or the like, and during a readout operation to read the flash memory, the system bus and high-speed memory interface, and the like, enter a wait state. Consequently, this presents a problem for the bus master in that the number of cycles required for the data transfer operation then increases. As a result, during the readout cycles to read the flash memory which are performed for the data transfer, the system bus cannot be used, and at the same time, the high-speed memory interface is also non-operable, which provokes a drop in the processing capacity of the microprocessor.

### SUMMARY OF THE INVENTION

Accordingly, it is an object of the present invention to provide a microprocessor which permits a reduction in the number of cycles required for external bus access to thereby raise the system bus usage efficiency and improve the processing capacity.

In order to achieve the above object, a first aspect of the present invention is a microprocessor including a bus master and a system bus, comprising: an external bus interface that functions as an interface between the system bus and an external bus connected to an external memory. The external bus interface comprises: (1) a batch read control section, which, in response to a batch read instruction from the bus master, repeatedly accesses the external bus in accordance with a batch read address, reads out data from the external memory and stores the data in a buffer; and (2) an access switching section, which, in response to an ordinary read instruction from the bus master following the batch read operation, outputs data stored in the buffer to the system bus without accessing the external bus when the corresponding ordinary read address is the batch read address.

According to the above aspect of the invention, in response to a batch read instruction from the bus master, the batch read control section in the external bus interface repeatedly accesses the external bus in accordance with a batch read address, and stores data in the buffer. During this external bus access, the system bus is open. Further, following completion of the batch read operation, when the address of the read instruction from the bus master is the same as the batch read address, the external bus interface outputs data stored in the buffer to the system bus without accessing the external bus. Therefore, even if the read operation latency resulting from external bus access is long, since the-system bus is not occupied during this interval, the bus master is capable of performing other processing with respect to the system bus, which makes it possible to raise the processing efficiency of the microprocessor. Further, because the bus master is able to simply supply the batch read instruction along with the corresponding address to the external bus interface before the read instruction to read the external bus, the processing efficiency can be raised by means of a simple constitution.

In order to achieve the above object, a second aspect of the present invention is a microprocessor including a bus master and a system bus, comprising: an external bus interface that functions as an interface between the system bus and an external bus which is connected to an external memory. The external bus interface is preset with the address of a batch write instruction by the bus master, and comprises: (1) an access switching section, which, in response to an ordinary write instruction from the bus master, stores write data in a buffer without accessing the external bus when the address of the ordinary write instruction is the batch write instruction address; and (2) a batch write control section, which, in response to a batch write instruction from the bus master, repeatedly accesses the external bus in accordance with the batch write instruction address, and writes data stored in the buffer to the external memory.

According to the above aspect of the invention, in response to a write instruction to write to the external bus issued by the bus master, the external bus interface temporarily stores the write data in the buffer without accessing the external bus. Then, in response to a subsequent batch write instruction, the external bus interface repeatedly writes the write data in the buffer to an external memory which is connected to the external bus. During the external bus access that results from the batch write instruction, the system bus is open, and hence, although the number of cycles for external bus access is large, the bus master is able to perform processing by using the system bus, which permits an increase in the processing efficiency.

In order to achieve the above object, a third aspect of the present invention is a microprocessor including a bus master and a system bus, comprising: a first external bus interface that functions as an interface between the system bus and a first external bus connected to a first external memory; and a second external bus interface that functions as an interface between the system bus and a second external bus connected to a second external memory. The microprocessor further comprises a common buffer that is connected via respective interface buses to the first and second external bus interfaces. In response to a data transfer instruction to transfer data from the first external memory to the second external memory, the data transfer instruction being issued by the bus master, the first external bus interface iterates external bus access to a transfer source address, reads out data from the first external memory, and stores the read out data in the common buffer via the interface bus, whereupon the second external bus interface iterates external bus access to a transfer destination address and writes the data stored in the common buffer to the second external memory.

According to the above aspect of the invention, when the bus master provides a data transfer instruction to the first and second external bus interfaces, these external bus interfaces execute a data transfer through repeated external bus access. Moreover, because this data transfer is performed via interface buses and a buffer which are separate from the system bus, the system bus is not occupied during external bus access. It is thus possible to raise the processing efficiency of the microprocessor.

### BRIEF DESCRIPTION OF THE DRAWINGS

FIG. 1 is a schematic constitutional view of the microprocessor of the present embodiment;

FIG. 2 shows an operation timing chart for external bus access according to the present embodiment;

FIG. 3 is a detail circuit diagram of the external bus interface according to the present embodiment;

FIG. 4 is a sequence diagram for a batch read operation;

FIG. 5 is a sequence diagram for a batch write operation;

FIG. 6 is a schematic constitutional view of the microprocessor of the second embodiment;

FIG. 7 is a sequence diagram for a data transfer operation using a FIFO buffer; and

FIG. 8 is a sequence diagram for a data transfer operation using a FIFO buffer.

### DESCRIPTION OF THE PREFERRED EMBODIMENTS

The embodiments of the present invention will be described hereinbelow with reference to the drawings. However, the scope of protection of the present invention is not limited to or by the embodiments below, but rather covers the inventions defined in the claims as well as any equivalents thereof.

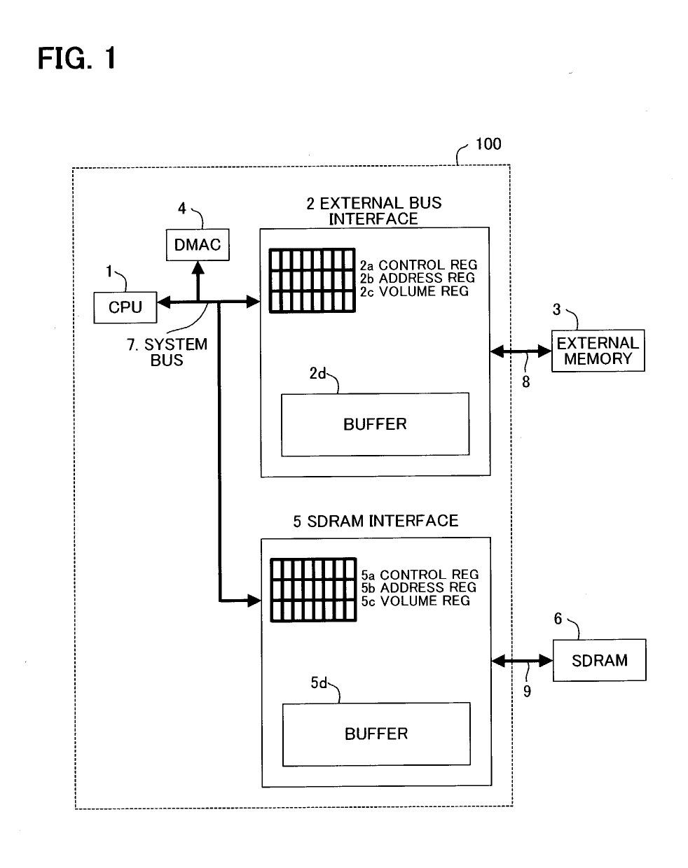

FIG. 1 is a schematic constitutional view of the microprocessor of the present embodiment. The microprocessor 100 comprises an internal system bus 7, and bus masters such as a CPU 1 and a direct memory access controller (DMAC) 4. The microprocessor 100 further comprises an external bus interface 2 that is connected to an external memory 3 such as a flash memory via a first external bus 8, and that functions as an interface with the first external bus. The microprocessor 100 further comprises an SDRAM interface 5 that is connected to a synchronous DRAM 6 via a second external bus 9, and that functions as an interface with this second external bus.

In response to an access instruction issued by the bus master to access the first external bus 8, the external bus interface 2 executes external bus access to thereby read out or write data in the external memory 3 according to the designated address. The external bus interface 2 outputs the data, which is read out from the external bus, to the system bus 7. Similarly, in response to an access instruction from the bus master to access the second external bus 9, the SDRAM bus interface 5 reads out data in the SDRAM 6, or writes data. The data thus read out is outputted to the system bus 7.

The external bus interface 2 and SDRAM interface 5 both comprise respective register groups 2a, 2b, 2c, and 5a, 5b, 5c, and respective buffers 2d and 5d, so as to be capable of performing batch read and write (batch access). The external bus interface 2 comprises: a control register 2a, which permits the setting of batch access command flags (batch read and batch write command flags), access status flags, which indicate that batch access is in progress (a read status flag, write status flag, and the like), access completion flags, which indicate that batch access is complete (a batch read completion flag, batch write completion flag, and the like), and so forth; an address register 2b, which sets an initial access address; and a volume register 2c, which sets the capacity of the external memory to be accessed. In place of the volume register 2c, a register for setting a final access address, or an access times and an address increment/decrement values, and the like, can also be provided. In either case, information that makes it possible to specify all the access addresses can also be set in this register. The SDRAM interface 5 also comprises a similar control register 5a, an address register 5b, and a volume register 5c.

After address information such as access addresses and capacities has been set in the above register groups by the bus master, when an access command flag is set by the bus master, the interfaces 2 and 5 automatically generate access addresses from the resister groups and then access the external memory 3 and SDRAM 6. The interfaces 2 and 5 temporarily store the read data which is read out from the external memory 3 and SDRAM 6 in the buffers 2d and 5d, without transferring this data to the system bus 7. The interfaces 2 and 5 temporarily store write data, which is supplied by the system bus 7, in the buffers 2d and 5d, without transferring this data to the external buses 8, 9. In response to the subsequent setting of batch write command flags, the interfaces 2 and 5 automatically generate access addresses from the register groups, and repeatedly write the write data stored in the buffers to the external memory 3 and SDRAM 6 respectively. In the course of the external bus access, the access status flags are set to batch access in progress flags which are used to perform arbitration to prohibit ordinary external bus access. Further, when the external bus access is complete, the access completion flag is set to complete.

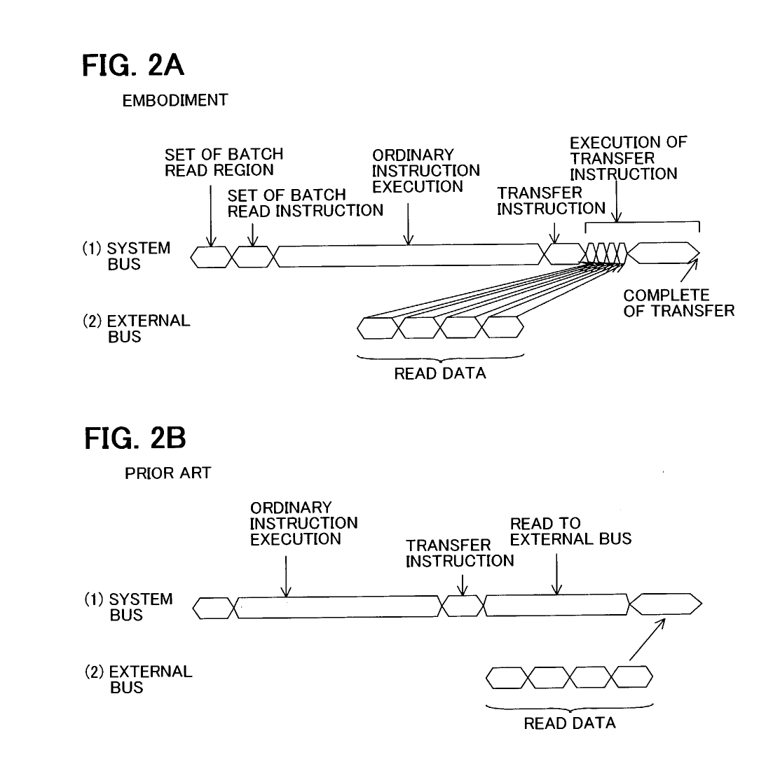

FIG. 2 shows an operation timing chart for external bus access according to the present embodiment. As shown in the conventional example in FIG. 2B, when the bus master issues a transfer instruction to the interfaces 2 and 5 via the system bus 7, external bus access is executed and the read data is read out. The read data thus readout is written to the external memories 3 and 6 from the interfaces 2 and 5 respectively which correspond to the transfer destinations. During this interval, the system bus 7 is in a wait state and is occupied, and it is not possible to execute other instructions.

Accordingly, as shown in FIG. 2A, in the present embodiment, when the bus master sets address information concerning batch read regions, in the register groups, and sets respective batch read command flags in the register groups, the addresses of the respective set batch read regions are generated by the interfaces 2 and 5, repeated read access to the external buses is executed and read data is stored in the buffers 2d and 5d. In the course of this external bus access, the system bus 7 is open, which permits the execution of an ordinary instruction. Also, when the batch read operation is complete, the issuing of a transfer instruction by the bus master causes the read data stored in the respective buffers in the interfaces 2 and 5 to be outputted to the system bus 7 and to be written to transfer destination addresses.

As described above, an operation corresponding to a batch read is displayed in the operation timing chart in FIG. 2. In the present embodiment, a batch write operation with respect to the external buses 8 and 9 can also be performed. Here, when the bus master sets address information in the respective register groups that indicates the batch write memory regions, the write data, which is to be written to the memory regions from the system bus 7, is temporarily stored in the respective buffers 2d and 5d in the interfaces 2 and 5. Further, when the bus master sets respective batch write command flags in the register groups, the interfaces 2 and 5 generate addresses of the set memory region and write the write data in the buffers to the external memories via the external buses. During the external bus access, the system bus 7 is open, and is available for the execution of another instruction.

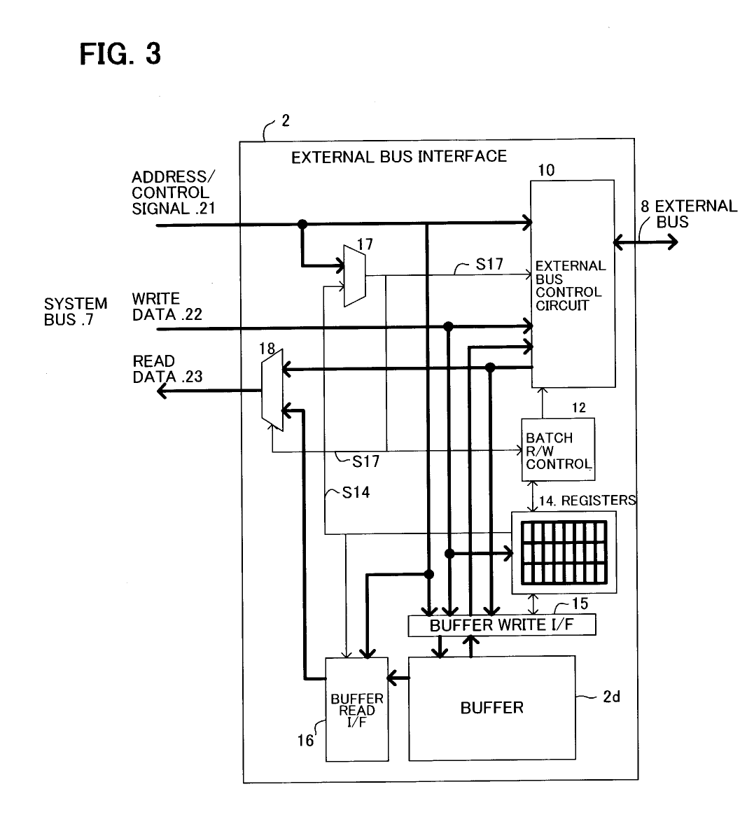

FIG. 3 is a detail circuit diagram of the external bus interface according to the present embodiment. The SDRAM interface 5 has a similar constitution. In addition to an external bus control circuit 10 for controlling ordinary external bus access, the external bus interface 2 shown in FIG. 3 comprises a register group 14, a buffer 2d, a batch read/write control circuit 12, and an access switching circuit 17. The buffer 2d is provided with a buffer write interface 15 and a buffer read interface 16.

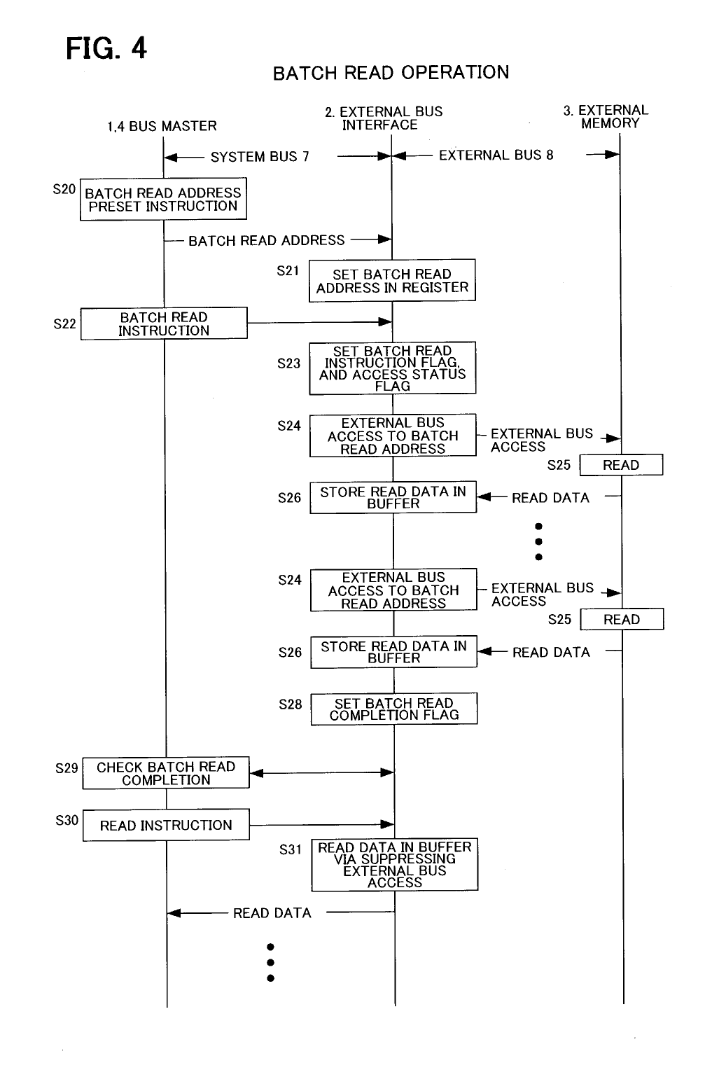

FIG. 4 is a sequence diagram for a batch read operation. A description of the batch read operation according to the present embodiment will now be provided with reference to the detail circuit diagram of FIG. 3 and the sequence diagram of FIG. 4. The bus master, namely the CPU 1 or DMAC 4, issues an instruction to preset an external memory address for performing a batch read (S20). Specifically, the bus master writes, via the system bus 7, a batch read start address in the address register 2b in the register group 14 and writes a batch read memory capacity in the volume register 2c. As a result, batch read address information is set in the register in the external bus interface (S21). In FIG. 3, a write data line 22 is connected to the register 14 and setting data from the bus master is written to the register 14.

The bus master then issues a batch read instruction (S22). Specifically, the bus master writes a command flag via the system bus 7 to a batch read command register in the control register 2a (S23). In response to this writing of the command flag, the batch read/write control circuit 12 in the external bus interface 2 sets the access status flag in the control register 2a to batch read in progress (S23), and starts the batch read operation to read the external memory.

In this batch read operation, the batch read/write control circuit 12 generates a batch read address from the start address and the memory capacity which are set in the register group, and executes external bus access to the batch read address (S24). In response to this external bus access, a read operation is executed in the external memory 3 (S25), and the read data is sent back via the external bus 8. In this external bus access, the batch read/write control circuit 12 repeatedly issues an external bus read instruction and address, in place of the bus master, and the external bus control circuit 10 iterates an external bus read by way of response. The read data sent back by the external bus 8 is stored in the buffer 2d via the buffer write interface 15 (S26). Accordingly, the corresponding relationship between the read address and the address in the buffer is held in the register 14 by the buffer write interface 15.

The external bus access operation of the above steps S24, S25 and S26 is iterated such that all the data of the memory region set in the register is stored in the buffer 2d. When all the read data has been stored in the buffer 2d, the batch read/write control circuit 12 sets the batch read completion flag, which is an access completion flag, to a completion state (S28).

During the above batch read operation, the system bus 7 is open, and the bus master is thus able to execute another instruction via the system bus 7. When the bus master issues an external bus access instruction, the external bus interface 2 performs external bus arbitration by responding to this external bus access instruction with a wait state, or responding by instructing access after a predetermined number of cycles, depending on whether or not the access status flag is access in progress. Therefore, when the batch read is complete, the access status flag is changed to no access in progress.

The bus master performs poling of the access completion flag in the register at predetermined intervals to check whether or not the batch read is complete (S29). If the access completion flag enters a complete state, the bus master confirms that the batch read operation is complete.

After confirming that the batch read is complete, the bus master issues a read instruction to read the batch-read memory region (S30). This read instruction is the same as an ordinary read instruction to read external memory, and a read instruction and read address are outputted via the system bus 7. The access switching circuit 17 in the external bus interface 2 compares this read address with the batch read address in the register 14. When these addresses match, because this constitutes a read instruction with respect to the batch-read data, the access switching circuit 17 generates a switching signal S17 and suppresses external bus access by the external bus control circuit 10. The selector 18 switches to the buffer read interface 16 as a result of the switching signal S17. Further, the address 21 supplied by the system bus 7 is supplied to the buffer read interface 16, the address in the buffer 2d is detected on the basis of the correspondence table in the register 14, and the read data of this address is outputted to the selector 18 (S31). As a result, the read data stored in the buffer is outputted to the system bus 7 as read data 23.

The access switching circuit 17 compares the read address from the system bus 7, and the batch read address in the register 14. When these addresses do not match, because this constitutes ordinary external bus access, the switching signal S17 is not outputted. The external bus control circuit 10 therefore executes external bus access as is performed normally.

As a result of the above read instruction S30 to read a batch read address being repeatedly issued by the bus master, the read data in the buffer is read out sequentially to the system bus 7. Because, in response to this read instruction S30, read data in the buffer in the external bus interface can be outputted to the system bus 7 without involving external bus access with long latency, the apparent latency for the bus master can be shortened.

As described above, in addition to the conventional read instruction that accompanies the transfer instruction, the bus master has only to set batch read address information and set a batch read command flag in advance in the register group. This setting instruction is preferably issued by a program before the program instruction that accompanies the batch read.

In the above embodiment, the system bus control need not be more complicated and highly functional in comparison with the prior art. It is sufficient to incorporate the register 14, the batch read/write control circuit 12, the buffer 2d, and the access switching circuit 17 in the external bus interface.

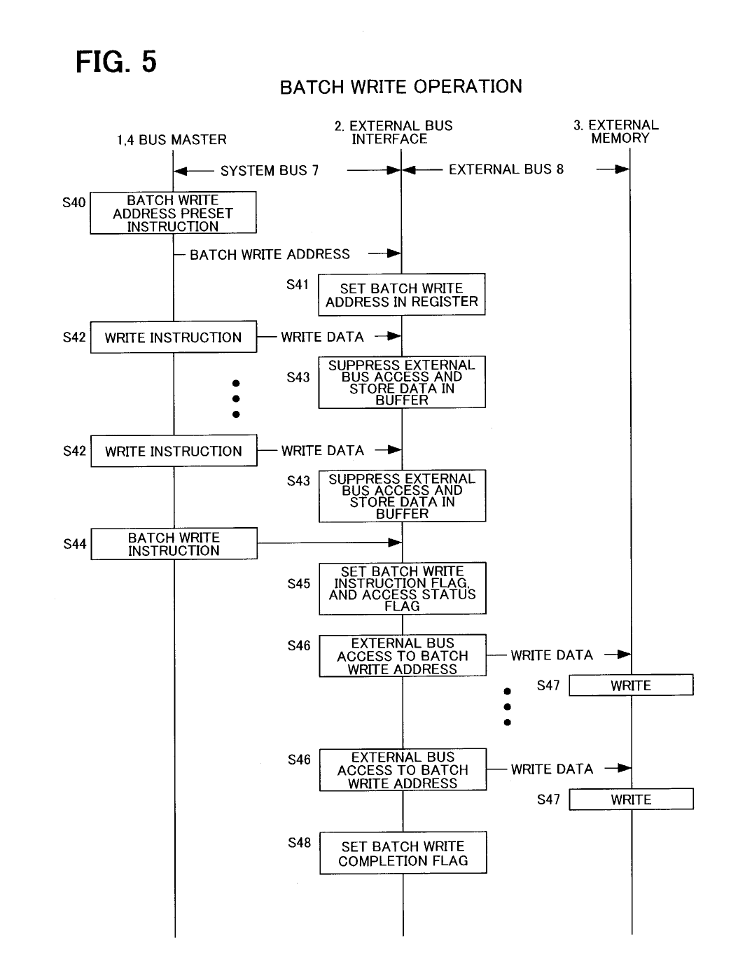

FIG. 5 is a sequence diagram for a batch write operation. A description will now be provided for the batch write operation referring to FIGS. 3 and 5. The bus master 1, 4 issues a batch write address setting instruction beforehand (S40). Specifically, information for the generation of batch write addresses is set in the register 14 in the external bus interface (S41). In the earlier example, a start write address and a memory capacity value are set in the register.

The bus master accordingly issues a write instruction to write to a batch write address (S42). This write instruction is the same as an ordinary external bus write instruction, and the bus master outputs a write instruction and a write destination address to the system bus 7. The access switching circuit 17 in the external bus interface 2 compares the write destination address thus supplied and the batch write address set in the register 14, and when these addresses match, outputs the switching signal S17 and suppresses external bus access by the external bus control circuit 10. Accordingly, write data 22, which is supplied via the system bus 7, is stored in the buffer 2d via the buffer write interface 15 (S43). Thereupon, the buffer write interface 15 generates a correspondence table for the address in the buffer and the write address and maintains this table in the register 14.

Batch write data is stored in the buffer in the external bus interface through iteration of the above write instruction S42. In response to this write instruction, the external bus interface 2 stores the write data in the internal buffer 2d without performing external bus access. Compared with a case where external bus access is actually performed, the number of cycles of this write instruction is therefore low.

The bus master then issues a batch write instruction (S44). Specifically, a batch write command flag is set in the register in the external bus interface. In response to this batch write command flag, the batch read/write control circuit 12 sets the access status flag to external bus access in progress (S45), generates a write address from the batch write address information in the register, and instructs the external bus control circuit 10 to access the external bus (S46). Accordingly, the buffer write interface 15 outputs the write data of the address in the buffer which corresponds to this write address to the external bus 8 via the external bus control circuit 10. The external memory 3 then performs the write operation (S47).

As a result of the repeated external bus access S46 by the batch read/write control circuit 12, the write data stored in the buffer 2d is repeatedly written to the external memory. When the writing to all the write addresses ends, the batch read/write control circuit 12 sets the batch write completion flag in the register to complete and, at the same time, changes the access status flag to no access in progress (S48).

Once the above batch write instruction S44 has been issued, the system bus 7 is open, and the bus master is thus able to execute another instruction by using the system bus. It is therefore possible to improve the processing efficiency of the microprocessor. During serial external access after the batch write instruction, because the access status flag is set to access in progress, when, during this interval, an external bus access request is issued by the bus master, arbitration to prohibit this external bus access is performed.

As can be understood from the batch read operation and the batch write operation according to FIGS. 4 and 5 respectively, when the data of the external memory 3, which is flash memory is transferred to the SDRAM 6 shown in FIG. 1, the bus master initially sets batch read address information in the external bus interface 2, and sets batch write address information in the SDRAM interface 5. The bus master also first sets the batch read flag in the external bus interface 2 to permit the execution of a batch read operation with respect to the external bus 8. The system bus 7 is open during this interval.

Upon confirming the batch read completion flag, the bus master issues a transfer instruction. The transfer instruction is constituted by repeated read and write instructions, and a variety of methods for issuing the transfer instruction may be considered, depending on the functions of the bus master.

In response to this transfer instruction, the external bus interface 2 outputs the read data stored in the buffer 2d to the system bus 7, and this read data is stored by the SDRAM interface 5 in the buffer 5d. When the transfer source address and transfer destination address pertaining to this transfer instruction match the batch read address and batch write address respectively, the interfaces 2 and 5 suppress access to the corresponding external bus and activate access to the internal buffers 2d and 5d. Since this transfer instruction does not involve external bus access, this instruction can be executed in short cycles.

Thereafter, the bus master sets the batch write command flag in the SDRAM interface 5 so that a data write to the SDRAM 6 is executed. The system bus 7 is open during this interval.

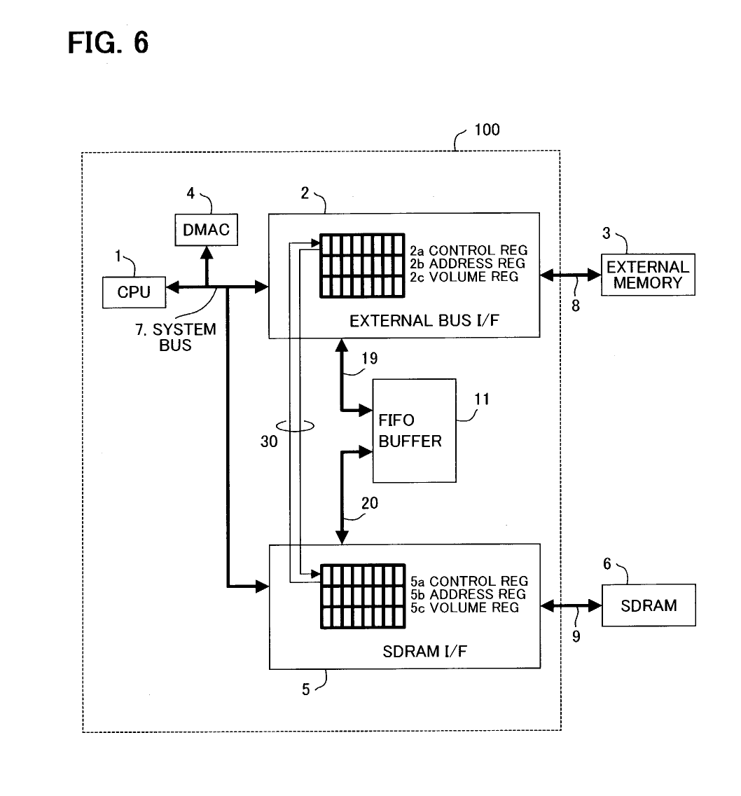

FIG. 6 is a schematic constitutional view of the microprocessor of the second embodiment. When this microprocessor 100 is compared with the microprocessor in FIG. 1, there is no buffer in the external bus interface 2 or the SDRAM interface 5. Instead, the interfaces 2 and 5 are provided with a common FIFO buffer 11. This FIFO buffer 11 is connected to the interfaces 2 and 5 via respective interface buses 19 and 20 provided separately from the system bus 7. In addition, the batch read completion flag register and the batch write command flag register of the respective control registers 2a and 5a of the two interfaces are connected to each other via a dedicated flag signal line 30.

Although omitted from FIG. 6, the interfaces 2 and 5 comprise the external bus control circuit 10 and batch read/write control circuit 12 in the constitution shown in FIG. 3. However, the interfaces 2 and 5 need not comprise the buffer 2d, the buffer write interface 15. the buffer read interface 16, the access switching circuit 17 or the selector 18.

In response to a data transfer instruction to transfer data from the external memory 3 to the SDRAM 6, this instruction being issued by the bus master, the external bus interface 2 of the microprocessor according to the second embodiment iterates external bus access to a transfer source address, performs a batch read, and sequentially stores the data thus read out in the common FIFO buffer 11 via the interface bus 19. The SDRAM interface 5 then iterates external bus access to the transfer destination address to perform a batch write. That is, the SDRAM interface 5 reads out the read data thus stored in the FIFO buffer, via the interface bus 20, and writes this read data to the SDRAM 6 of the transfer destination address.

In this embodiment, the bus master presets batch read address information in the external bus interface 2 and presets batch write address information in the SDRAM interface 5. The bus master is then capable of issuing a transfer instruction simply by setting the batch read command flag in the external bus interface 2. When the external bus interface 2 has completed the batch read operation and sets the batch read completion flag, the batch write command flag in the SDRAM interface 5 is automatically set via the flag signal line 30. Byway of response, the SDRAM interface 5 writes the read data in the FIFO buffer 11 to the SDRAM. Because the FIFO buffer 11 comprises a function for controlling a write pointer and a read pointer, read data is written to the FIFO buffer and read out from the FIFO buffer by means of this function.

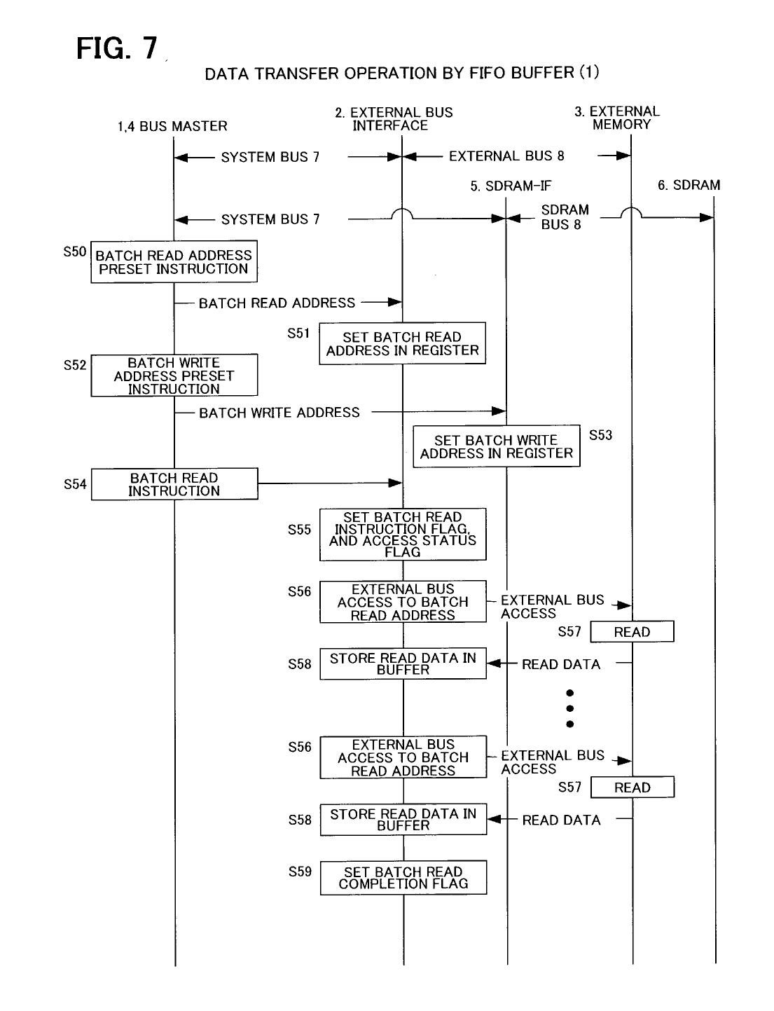

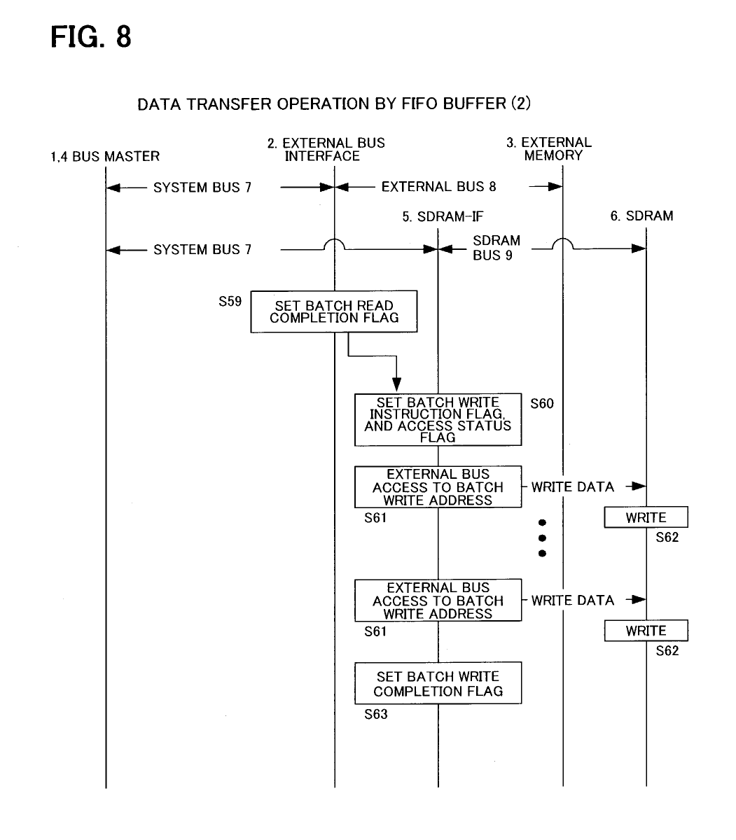

FIGS. 7 and 8 are sequence diagrams for a data transfer operation using the FIFO buffer. A description is provided for a case where data in the external memory 3, which is a flash memory, is transferred to the SDRAM 6. The bus master initially sets a batch read address in the register in the external bus interface 2 (S50, S51). This setting of the read address can involve setting of address information permitting the generation of a read address, such as a start address and a memory capacity, and the like. The bus master also sets a batch write address in the register in the SDRAM interface 5 (S52 and S53).

The bus master then issues a batch read instruction (S54). Specifically, the bus master sets the batch read command flag in the control register 2a of the external bus interface 2. In response to this setting, the batch read/write control circuit 12 in the external bus interface 2 sets the access status flag to access in progress (S55). The control circuit 12 also generates a batch read address on the basis of the set address information to thereby cause the external bus control circuit 10 to perform a read operation to read the external memory 3 (S56). By way of response, the external memory 3 performs the read operation (S57) and the corresponding read data is stored by the external bus control circuit 10 in the FIFO buffer 11, via the interface bus 19 (S58). As a result of iterating this external bus access S56, S57, S58, all the data pertaining to the transfer instruction is read out from the external memory 3 and stored in the FIFO buffer 11.

When the batch read operation ends, the batch read/write control circuit 12 sets the batch read completion flag in the control register 2a (S59).

As shown by FIG. 8, when the batch read completion -flag is set in the external bus interface 2, the batch write command flag in the SDRAM interface 5 is set at the same time via the flag signal line 30 (S60). In response to this setting of the batch write command flag, the batch read/write control circuit 12 in the SDRAM interface 5 sets the access status flag (S60). The control circuit 12 also generates a write address on the basis of the address information set in the register so that the external bus control circuit 10 executes a write operation to the SDRAM 6 (S61). The write data at this time is outputted from the FIFO buffer 11 to the SDRAM bus 9 via the interface bus 20. By way of response, the SDRAM 6 performs a write operation (S62). As a result of iterating the above batch write operation S61, S62, all the data in the FIFO buffer is written to the SDRAM 6.

As detailed above, the bus master initially sets batch read address information and batch write address information and is thus capable of completing a transfer instruction simply by subsequently setting a batch read command flag. Thereafter, through linkage of the bus interfaces 2 and 5, a batch read of the external memory 3 and a batch write to the SDRAM are performed. Accordingly, after setting the batch read command flag, the system bus 7 is open and the bus master is capable of executing another instruction. Because the transfer data is transferred via the interface buses 19 and 20, which are separate from the system bus 7, a reduction in the number of cycles during which the system bus 7 is occupied is permitted.

According to the present invention described hereinabove, an external bus interface is provided with a batch read function and a batch write function, which permit a reduction in the number of cycles required by an external read instruction and external write instruction respectively from the bus master. It is thus possible to increase the processing efficiency of the microprocessor.

What is claimed is:

1. A microprocessor comprising:
a bus muster;
a system bus connected to the bus master; and
an external bus interface, which is connected via an external bus to an external memory and which functions as an interface between said system bus and said external bus, wherein the external bus interface comprises: a batch read control section, which, in response to a batch read instruction from said bus master, repeatedly accesses the external bus in accordance with a batch read address, reads out data from said external memory and stores the read data in a buffer; and an access switching section, which, in response to an ordinary read instruction from the bus master following said batch read operation, outputs data stored in said buffer to said system bus without accessing the external bus when the corresponding ordinary read address matches said batch read address.

2. The microprocessor as claimed in claim 1, wherein said external bus interface comprises an address register for setting information with regard to said batch read address.

3. The microprocessor as claimed in claim 1, wherein said external bus interface further comprises an external bus control circuit for controlling external bus access; and a selector for transferring read data received from said external bus to said system bus at the time of a read instruction to the external bus which has an address other than said batch read address, and for transferring data stored in said buffer to said system bus at the time of a read instruction to the external bus with respect to said batch read address.

4. The microprocessor as claimed in claim 1, wherein, during said batch read, said system bus is open and available for predetermined processing by said bus master.

5. A microprocessor comprising:
a bus master;
a system bus connected to said bus master; and
an external bus interface that functions as an interface between said system bus and an external bus connected to an external memory,
wherein the external bus interface is preset with the address of a batch write instruction by said bus master, and comprises an access switching section, which, in response to an ordinary write instruction from said bus master, stores write data in a buffer without accessing the external bus when an address of the ordinary write instruction matches said batch write instruction address; and a batch write control section, which, in response to a batch write instruction from said bus master, repeatedly accesses the external bus in accordance with said batch write instruction address, and writes data stored in said buffer to the external memory.

6. The microprocessor as claimed in claim 5, wherein said external bus interface comprises an address register for setting information with regard to said batch write address.

7. The microprocessor as claimed in claim 5, wherein said external bus interface further comprises an external bus control circuit for controlling external bus access.

8. The microprocessor as claimed in claim 5, wherein, during said batch write, said system bus is open and available for predetermined processing by said bus master.

9. A microprocessor including a bus master and a system bus connected to said bus master, comprising:
a first external bus interface that functions as an interface between said system bus and a first external bus connected to a first external memory;
a second external bus interface that functions as an interface between said system bus and a second external bus connected to a second external memory; and
a common buffer that is connected via respective interface buses to said first and second external bus interfaces,
wherein, in response to a data transfer instruction to transfer data from said first external memory to said second external memory, which is issued by said bus master, said first external bus interface iterates external bus access to a transfer source address, reads out data from said first external memory, stores the read data in said common buffer via said interface bus, whereupon said second external bus interface iterates external bus access to a transfer destination address and writes the data stored in said common buffer to said second external memory.

10. The microprocessor as claimed in claim 9, wherein said first and second external bus interfaces each comprises a register for setting information with regard to a transfer source address and transfer destination address.

11. The microprocessor as claimed in claim 9, wherein, once said data transfer instruction has been issued by said bus master, said system bus is open and available for predetermined processing by said bus master.

12. The microprocessor as claimed in claim 9, wherein, upon completion of a read operation to read said first external memory, said first external bus interface instructs said second external bus interface to perform a write operation to write to said second external memory.
